(19) United States
(12) Patent Application Publication
(10) Pub. No.: US 2012/0272145 A1
(43) Pub. Date: Oct. 25, 2012

(54) METHOD FOR USING RADIO PRESETS AS APPLICATION SHORTCUTS

(75) Inventors: David Lee Ryan, Peachtree City, GA (US); Ram Prasad Bojanki, Peachtree City, GA (US)

(73) Assignee: Panasonic Automotive Systems Company of America, Division of Panasonic Corporation of North America, Peachtree City, GA (US)

(21) Appl. No.: 13/092,200

(22) Filed: Apr. 22, 2011

(51) Int. Cl. G06F 3/01

(52) U.S. Cl. 715/702; 715/740

(57) ABSTRACT

A control arrangement for a vehicle includes an infotainment console having a user interface with a plurality of pushbuttons. A communication device is communicatively coupled to the infotainment console and relays signals between the infotainment console and a portable computing device. The infotainment console reconfigures the user interface to enable the user to control the portable computing device via the user interface. Each of the pushbuttons is actuatable to cause operation of the portable computing device to proceed to a respective application within the portable computing device.

### BACKGROUND OF THE INVENTION

1. Field of the Invention

The present invention relates to portable computing devices and, more particularly, to apparatuses and methods for controlling portable computing devices.

2. Description of the Related Art

Many portable advanced mobile devices today contain very powerful processors and large amounts of memory. These devices include smartphones, cell phones, music players, network appliances, and personal navigation devices. These devices contain many valuable and complex applications including games, rich media, navigation, information management, etc. However, the significant computing power available in these devices is still constrained by a small display and small speakers required by the mobile environment. Because of the size limitations and other reasons, users of advanced mobile devices are commonly confused by the user interfaces of these devices.

Many vehicles include entertainment systems having components such as radios, DVD (digital video disc) players, CD (compact disc) players, cameras and navigational systems to provide entertainment and information to the driver. These components are controlled using a user interface in the form of a control panel typically having many pushbuttons, knobs, screens and other devices. A user typically becomes very familiar with the control panel of his vehicle, and this familiarity enables the user to use the control panel safely while driving. Moreover, the control panel is designed to be used while the user is driving, and thus effectively accommodates limitations in the attention, viewing time, and tactile precision of the user as he simultaneously performs the driving task.

What is neither described nor suggested in the prior art is a way to fully take advantage of the more sophisticated and user-friendly user interface of a remote peripheral device such as an automobile to control a portable computing device such as a smartphone.

### SUMMARY

The present invention provides an apparatus and method for enabling a remote system such as a vehicle infotainment system to configure its user interface such that the interface may be used to control a portable computing device such as a smartphone, cell phone, web pad, media player, navigation device, etc. Thus, in general, the display, audio and input controls of the portable device may be exported to a remote screen, speakers and input devices when a larger, more robust system of a remote peripheral system is available, such as that of an automobile.

In one aspect, the present invention enables the preset pushbuttons of the automotive entertainment system to be used to access features or applications of a smartphone or other mobile electronic device. When the entertainment system is operating independently (i.e., not in communication with a mobile electronic device), the preset pushbuttons are programmed to tune in particular frequencies of the AM and/or FM frequency bands, or of XM/Sirius stations, as is known in the prior art. However, according to the invention, when the entertainment system is in communication with a mobile electronic device, the preset pushbuttons may be actuated to implement shortcuts to features and/or applications of the mobile device. For example, the preset pushbuttons may be actuated to implement shortcuts to feature such as the “user settings” page, or an application such as Pandora interne radio, or a station within Pandora, such as “Rolling Stones Radio.”

The present invention addresses the problem of limited area on the display screen of the user interface to place short-cut icons that activate functions of the radio and/or mobile device.

In one embodiment, the present invention comprises a control arrangement for a vehicle including an infotainment console having a user interface with a plurality of pushbuttons. A communication device is communicatively coupled to the infotainment console and relays signals between the infotainment console and a portable computing device. The infotainment console reconfigures the user interface to enable the user to control the portable computing device via the user interface. Each of the pushbuttons is actuatable to cause operation of the portable computing device to proceed to a respective application within the portable computing device.

In another embodiment, the present invention comprises a control method, including providing an automotive infotainment console having a first user interface with a plurality of pushbuttons. A portable computing device is provided having a second user interface and being operable to run a plurality of applications. The portable computing device is communicatively coupled to the infotainment console. The first user interface is automatically reconfigured to replicate controls of the second user interface such that each of the pushbuttons is actuatable to cause operation of the portable computing device to proceed to a respective one of the applications.

In yet another embodiment, the present invention comprises a control arrangement for a vehicle including a head unit of an audio entertainment system having a user interface with a display screen and a plurality of radio preset pushbuttons disposed adjacent to the display screen. A communication device is communicatively coupled to the audio entertainment system and relays signals between the audio entertainment system and a smartphone. The audio entertainment system reconfigures the user interface to enable the user to control the smartphone via the user interface, such that a plurality of application icons appear on the display screen. Each of the application icons represents a respective application within the smartphone. Each of the application icons is disposed adjacent to a respective one of the pushbuttons. Each of the pushbuttons is actuatable to cause the smartphone to run the respective application. A plurality of application category icons are displayed on the display screen simultaneously with the application icons. Each of the application category icons is selectable to cause a respective category of the applications to be presented on the display screen.

An advantage of the present invention is that it enables the user to use shortcuts of the mobile device by use of well known user interface pushbuttons that are traditionally used as radio station presets. Thus, distraction of the driver, which is a hazard, is minimized. That is, the invention minimizes driver distraction by providing a well known user interface to control advanced features.

Another advantage of the present invention is that it expands the possible uses of the user preset pushbuttons. The benefit provided to the end user is more flexibility to customize the user interface and simplify the user experience.

Yet another advantage of the present invention is that it supports multi-application and multi-platform development.

A further advantage of the invention is that it requires a minimum of maintenance.

Still another advantage of the invention is that it provides a streamlined user interface.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a block diagram of a mobile electronic device control arrangement in accordance with one embodiment of the present invention;

FIG. 2a is a schematic representation of one embodiment of a smartphone including an icon for an OEM application that may be used in conjunction with the present invention;

FIG. 2b is a schematic representation of the smartphone of FIG. 2a with the OEM application in the process of loading;

FIG. 2c is a schematic representation of the smartphone of FIG. 2a with the OEM application having been loaded;

FIG. 3a is a schematic representation of the smartphone of FIG. 2c with the “Your Apps” selection having been selected;

FIG. 3b is a schematic representation of the smartphone of FIG. 3a with the “Facebook” application having been selected;

FIG. 3c is a schematic representation of the smartphone of FIG. 3b after the user has logged in on the “Facebook” application;

FIG. 4a is a schematic representation of the smartphone of FIG. 2c with the “App Store” selection having been selected;

FIG. 4b is a schematic representation of the smartphone of FIG. 4a with the “Music/Radio” application having been selected;

FIG. 5a is a schematic representation of the smartphone of FIG. 2c with the “More” selection having been selected;

FIG. 5b is a schematic representation of the smartphone of FIG. 5a with the “Head Unit Settings” selection having been selected;

FIG. 6 is a schematic representation of the smartphone of FIG. 2c when connected to the head unit of the vehicle;

FIG. 7a is a schematic representation of the home screen of the head unit of FIG. 1 when very few applications are supported;

FIG. 7b is a schematic representation of the display screen of FIG. 7a after the user has selected the smartphone icon;

FIG. 7c is a schematic representation of the display screen of FIG. 7b after the user has selected the Last.fm icon;

FIG. 8a is a schematic representation of the home screen of the head unit of FIG. 1 when many applications are supported;

FIG. 8b is a schematic representation of the display screen of FIG. 8a after the user has selected the smartphone icon, and five pushbuttons under the display screen;

FIG. 8c is a schematic representation of the display screen of FIG. 8b after the user has selected the music icon;

FIG. 9a is a schematic representation of the display screen of FIG. 8a after the user has selected the smartphone icon, having a different arrangement of the same content as shown in FIG. 8b;

FIG. 9b is a schematic representation of the display screen of FIG. 9a after the user has selected the music icon;

FIG. 9c is a schematic representation of the display screen of FIG. 9a after the user has selected the traffic and navigation icon;

FIG. 9d is a schematic representation of the display screen of FIG. 9a after the user has selected the weather icon;

FIG. 10a is another schematic representation of the display screen of FIG. 9a after the user has selected the music icon;

FIG. 10b is a schematic representation of the display screen of FIG. 10a after the user has selected the Last.fm selection;

FIG. 10c is a schematic representation of the display screen of FIG. 10b after the user has selected the music icon;

FIG. 11a is another schematic representation of the display screen of FIG. 10a after the user has selected the Last.fm selection;

FIG. 11b is a schematic representation of the display screen of FIG. 11a after the user has selected the smartphone icon;

FIG. 12 is a flow chart of one embodiment of a control method of the present invention.

Corresponding reference characters indicate corresponding parts throughout the several views. Although the drawings represent embodiments of the present invention, the drawings are not necessarily to scale and certain features may be exaggerated in order to better illustrate and explain the present invention. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

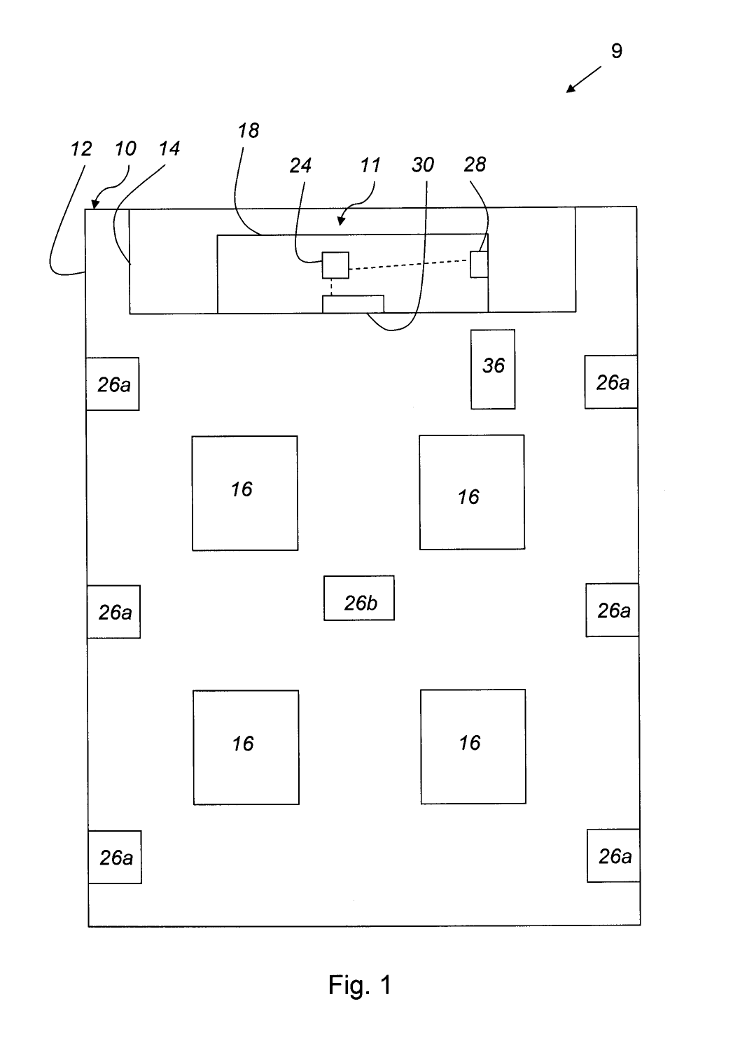

Referring to FIG. 1, a portable computing device control arrangement 9 including a portable computing device 36 disposed within a vehicle 10 is illustrated. Vehicle 10 may be equipped with an infotainment system 11 and generally includes vehicle body 12 defining an interior space. Vehicle 10 includes dashboard 14 disposed within the interior space and extending along the front of vehicle body 12, and seats 16 disposed within the interior space. Infotainment system 11 generally includes infotainment console 18, output units 26a-26b communicatively coupled to infotainment console 18 and wireless communication device 28 communicatively coupled to infotainment console 18.

Infotainment console 18 also includes a user interface 30, which is communicatively coupled to an application program interface 24. Application program interface 24 may be in the form of, and include, any application program interface, processor, source code, object code, software, implementations or other programs useful in operating user interface 30 as well as infotainment applications (not shown). User interface 30 is adapted to receive commands from the user and allows the user to control the operation of application program interface 24 and, ultimately, the infotainment applications. User interface 30 may be in any form suitable for allowing the user to operate application program interface 24. For instance, user interface 30 may include pushbuttons, dials, scroll wheels, a keyboard, a touch pad, a voice recognition device, a display screen, a mouse and/or other user interface devices.

Referring still to FIG. 1, output units 26a-26b are communicatively coupled to infotainment console 18 and are adapted to receive the output signals generated by infotainment console 18. Output units 26a-26b are configured to broadcast an output in the form that the user may recognize and enjoy. Output units 26a-26b may be any device capable of generating such an output. For instance, output units 26a-26b may include audio speakers 26a positioned throughout the interior space defined by vehicle body 12 and adapted to broadcast audio/sound through the interior space. Alternatively, or additionally, output units 26a-26b may include visual display unit 26b, such as a monitor or other video display unit, capable of displaying visual images.

Infotainment system 11 also includes wireless communication device 28, which is communicatively coupled and connected to infotainment console 18. Wireless communication device 28 is adapted to transmit information to a portable/mobile electronic device 36 and receive information from portable/mobile electronic device 36. Wireless communication device 28 may be any communication device capable of wirelessly communicating with a portable/mobile electronic device. For instance, wireless communication device 28 may be in the form of a short range communications device such as a radio frequency communications module, a Wi-Fi communications module, IEEE 802.11 communications module, or a Bluetooth communications module. Portable/mobile electronic computing device 36 may be in the form of a smartphone, cellular phone, personal data assistance (PDA), iPhone, Blackberry®, laptop computer or other wireless communications device.

Portable/mobile electronic computing device 36 is described herein as being primarily a wireless device. However, it is within the scope of the invention for infotainment console 18 to be selectively, removably and/or temporarily hardwired to portable computing device 36, and for communication to occur therebetween via the hardwired connection.

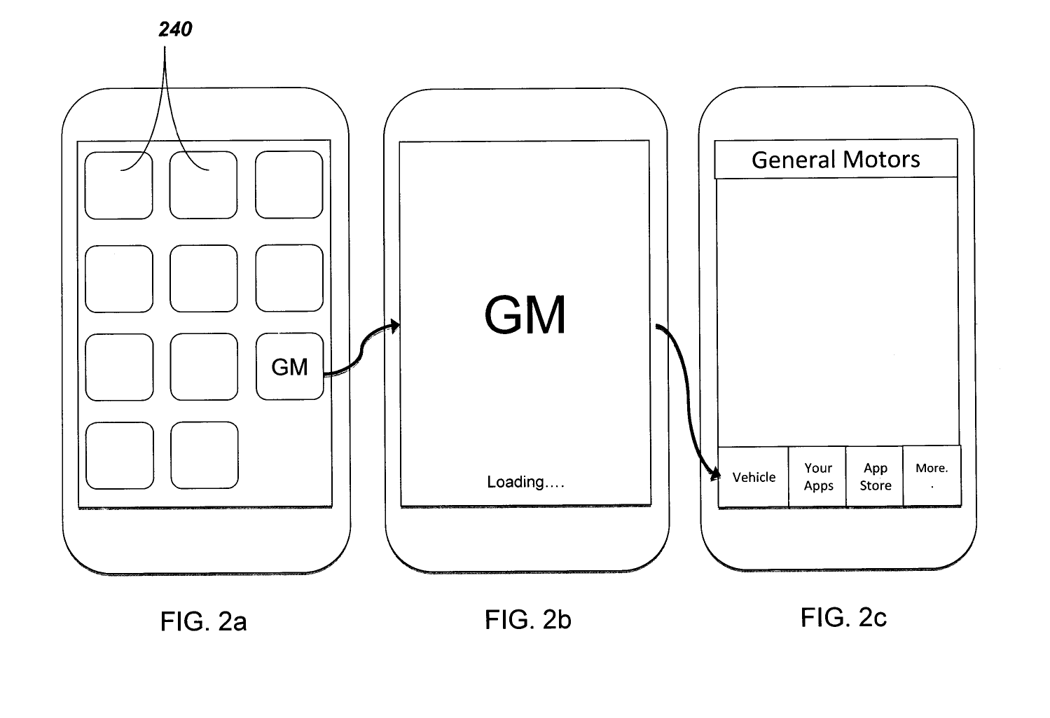

Referring now to FIGS. 2a-c, one specific embodiment of a mobile electronic device, such as device 36, in the form of a smartphone is shown including a display screen and a number of icons 240 representing various applications available on the smartphone. One particular icon 240, labeled “GM,” represents an application that may enable the smartphone to be controlled via the user interface, such as user interface 30, of an automobile in which the smartphone is disposed. The application represented by the “GM” icon may be referred to herein as an original equipment manufacturer (OEM) application.

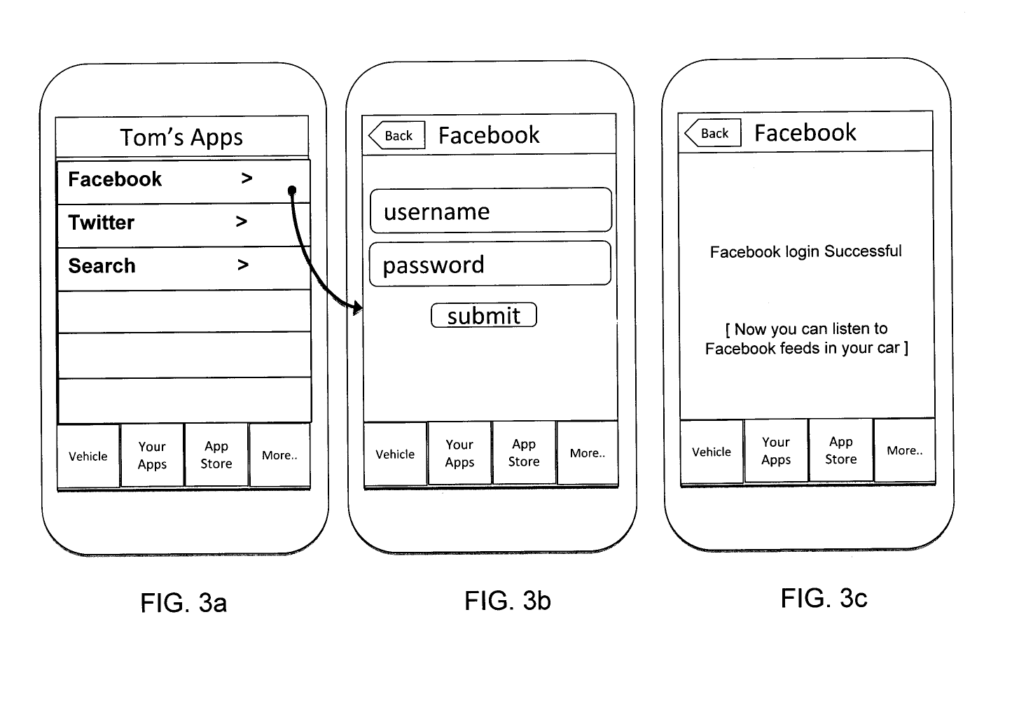

FIG. 2b illustrates the smartphone as the OEM application is loading, such as in response to the user touching the “GM” icon. FIG. 2c illustrates the smartphone with the OEM application having been loaded. The display screen includes a plurality of touch-sensitive selections, including “Vehicle”, “Your Apps”, “App Store”, and “More”. In the example shown in FIG. 2c, the “Vehicle” selection has been selected by the user, or is selected by default upon loading, as may be indicated by the “Vehicle” selection being highlighted (not shown). FIGS. 3a-c illustrate built-in applications/support of the smartphone of FIG. 2c. More particularly, FIG. 3a illustrates the smartphone of FIG. 2c after the user has selected the “Your Apps” selection. The user, whose name is “Tom” in this example, has programmed into the smartphone applications including “Facebook”, “Twitter” and “Search”.

FIG. 3b illustrates the smartphone of FIG. 3a after the user has selected the “Facebook” application, such as by touching the arrow next to “Facebook” in FIG. 3a. FIG. 3c illustrates the smartphone of FIG. 3b after the user has logged in on the “Facebook” application by entering his username and password into the appropriate fields and touching the “submit” icon. As indicated in FIG. 3c, the user at this point is able to listen to Facebook feeds in the automobile.

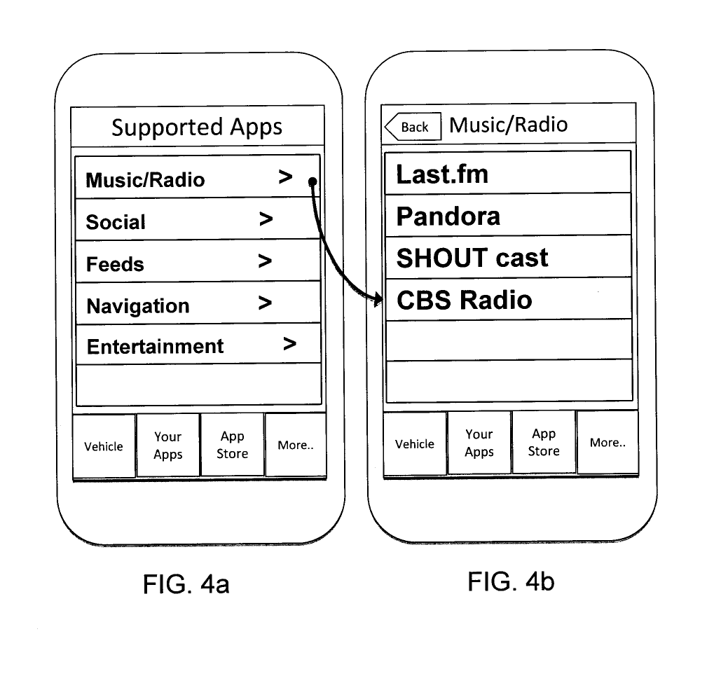

FIG. 4a illustrates the smartphone of FIG. 2c after the user has selected the “App Store” selection. As shown in FIG. 4a, supported applications include “Music/Radio”, “Social”, “Feeds”, “Navigation”, and “Entertainment”.

FIG. 4b illustrates the smartphone of FIG. 4a after the user has selected the “Music/Radio” application. As shown in FIG. 4b, selections in the “Music/Radio” application include “Last.fm”, “Pandora”, “SHOUT cast”, and “CBS Radio”.

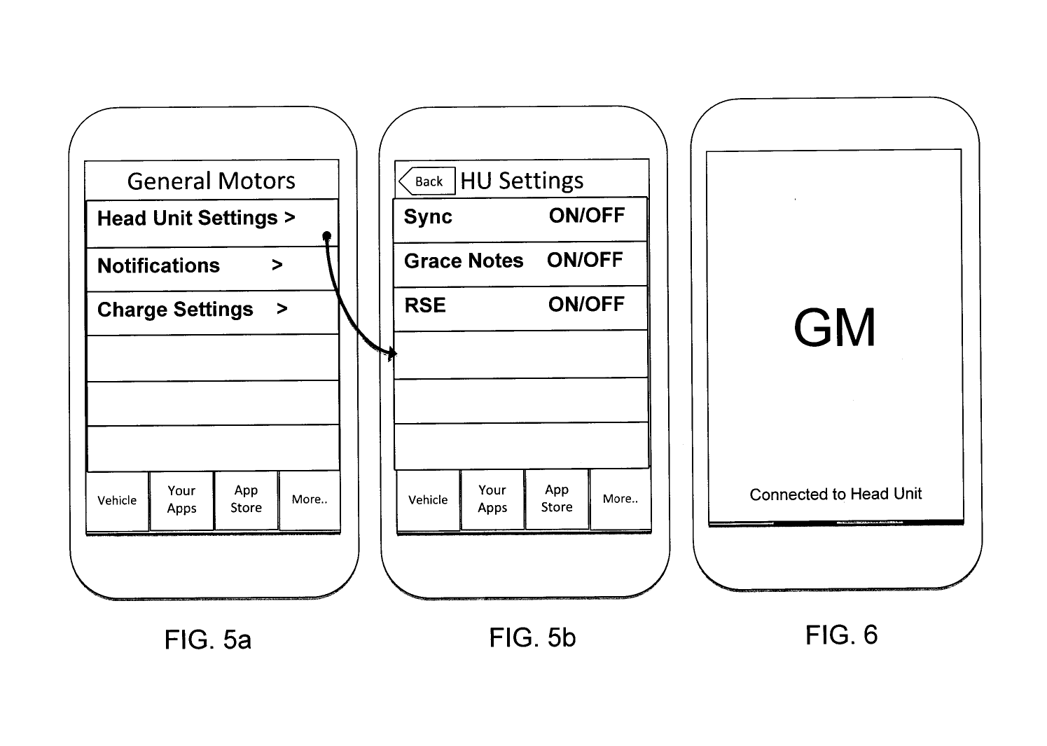

FIG. 5a illustrates the smartphone of FIG. 2c after the user has selected the “More” selection. As shown in FIG. 5a, additional selections presented to the user after selecting the “More” selection are directed to, and are particular to, the vehicle with which the smartphone is in communication. In this case, the vehicle is a vehicle marketed by General Motors. The additional selections include “Head Unit Settings”, “Notifications”, and “Charge Settings”.

FIG. 5b illustrates the smartphone of FIG. 5a after the user has selected the “Head Unit Settings” selection. As shown in FIG. 5b, Head Unit settings that may be turned ON or OFF by the user include “Sync”, “Grace Notes”, and “RSE”, each of which may refer to a type of radio service or radio program.

FIG. 6 illustrates the smartphone of FIG. 2c after the user has connected the smartphone to the head unit of the vehicle. For example, the user may hard wire the smartphone to the head unit via a cable. Alternatively, the user may provide user inputs to the smartphone and/or the head unit to thereby establish a wireless connection. When connected to the head unit, the smartphone may not take or accept any further user inputs through the user interface of the smartphone (e.g., touch/hard pushbuttons). As shown in FIG. 6, the smartphone may display some type of splash screen that indicates the status of the smartphone being connected to the head unit. Similarly, the splash screen may also indicate when the smartphone is disconnected from the head unit.

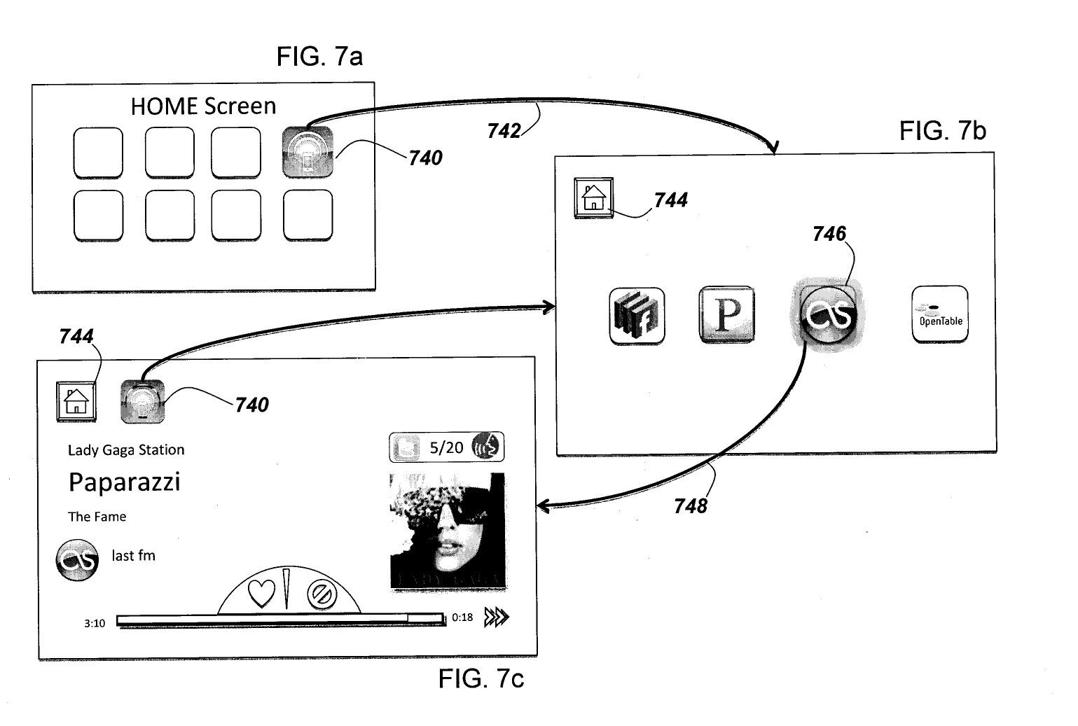

FIGS. 7a-c illustrates one embodiment of how smartphone application screens may be presented on the head unit. Infotainment console 18 may interrogate portable computing device 36, and portable computing device 36 may respond to the queries with information describing the layout and function of the smartphone's user interface.

FIGS. 7a-c illustrates one embodiment of the display screen of user interface 30 after having received answers to the user interface configuration queries. The display screen of user interface 30 is reconfigured to mimic the display screen of portable device 36.

The embodiment depicted in FIGS. 7a-c may be particularly appropriate when very few applications are supported (e.g., five or fewer applications). FIG. 7a illustrates the home screen of the head unit including a matrix of icons arranged in rows and columns. The user may select the smartphone icon 740, as indicated by arrow 742, thereby causing the display screen of the head unit to display the four icons shown in FIG. 7b, each of which may represent an application available on the smartphone (i.e., Facebook, Pandora, Last.fm, and OpenTable). The user also has the option to select the home icon 744, which would cause the head unit to return to the display shown in FIG. 7a.

The user may select the Last.fm icon 746, as indicated by arrow 748, thereby causing the display screen of the head unit to display the Last.fm screen shown in FIG. 7c. On this screen too, the user has the option of selecting the smartphone icon 740 to thereby cause the display screen of the head unit to revert to the display shown in FIG. 7b. Here too, the user has the option to select the home icon 744, which would cause the head unit to return to the display shown in FIG. 7a.

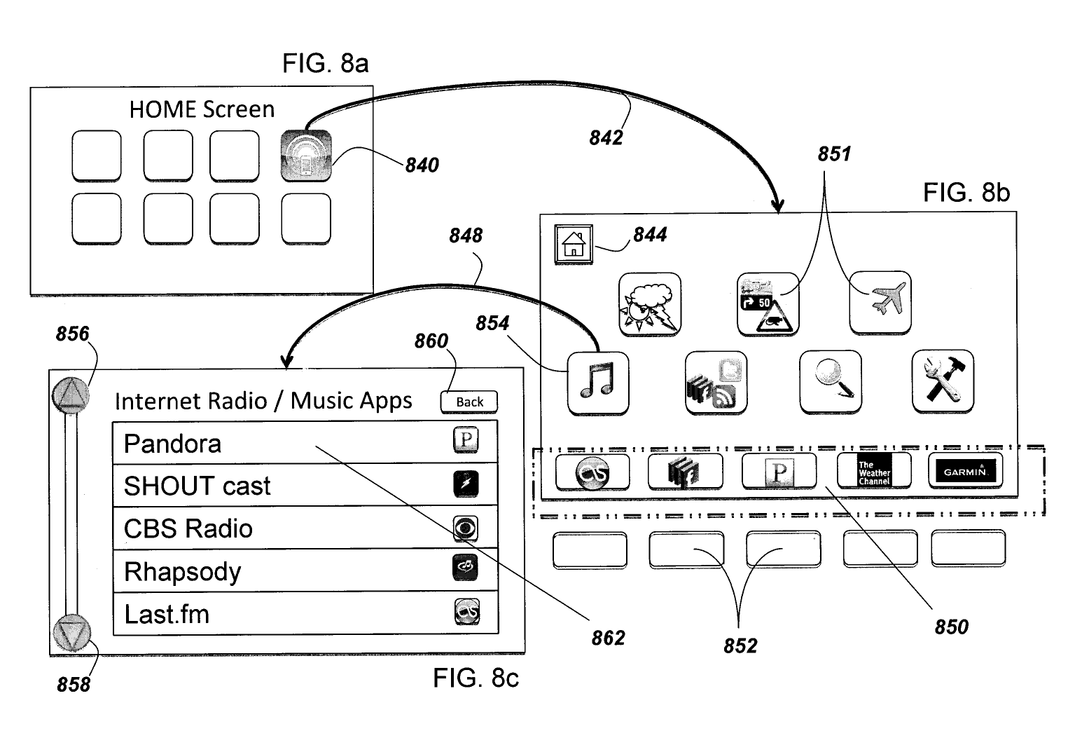

FIGS. 8a-c illustrate another embodiment of how smartphone application screens may be presented on the head unit. The embodiment depicted in FIGS. 8a-c may be particularly appropriate when a large number of supported applications are available (e.g., six or more applications). FIG. 8a illustrates the home screen of the head unit including a matrix of icons arranged in rows and columns. The user may select the smartphone icon 840, as indicated by arrow 842, thereby causing the display screen of the head unit to display the thirteen icons shown in FIG. 8b, including the home icon 844, the selection of which would cause the head unit to return to the display shown in FIG. 8a. The other twelve icons are arranged in three rows, with each of the seven icons in the top two rows representing a respective application category.

The five icons in the bottom row each may represent a respective favorite application of the user, which in this example are Last.fm, Facebook, Pandora, The Weather Channel and Garmin. These five icons are shown within an imaginary dashed and dotted rectangle in FIG. 8b that signifies that these five icons comprise a group 850 of shortcuts to the favorite applications. These five favorite icons may be referred to as “shortcuts” because selection of any one of these five icons causes operation to proceed directly to the respective application, rather than to just a display of applications within a particular category, as is the case with the icons 851 in the top two rows of FIG. 8b.

A respective one of five hard pushbuttons 852 is disposed directly below each of the shortcut icons 850, along an edge of the display screen. The display screen may or may not be touch-sensitive in the area within the imaginary dashed and dotted rectangle in FIG. 8b, and thus in order to select one of the shortcut icons 850, the user may depress the pushbutton 852 that is disposed directly below the shortcut icon 850 to be selected.

The user may select the music icon 854, as indicated by arrow 848, thereby causing the display screen of the head unit to display a menu of the available internet radio and other music applications. In this example shown in FIG. 8c, the menu of music applications that are currently displayed on the screen includes Pandora, SHOUT cast, CBS Radio, Rhapsody and Last.fm. The user may scroll up and down the list of menu items by touching UP arrow icon 856 and/or DOWN arrow icon 858. Alternatively, the user has the option of selecting the back icon 860 to thereby cause the display screen of the head unit to revert to the display shown in FIG. 8b.

In order to establish an application as a one of shortcuts 850, a user may depress one of the application selections in FIG. 8c, such as the Pandora selection 862, with a key press of relatively long time duration (e.g., three seconds or more). The system may retain the five applications that have been most recently selected as shortcuts 850. Although the Pandora selection is already shown as a shortcut in FIG. 8b, performing a long key press on selection 862 may nevertheless establish Pandora as the most recently selected shortcut application.

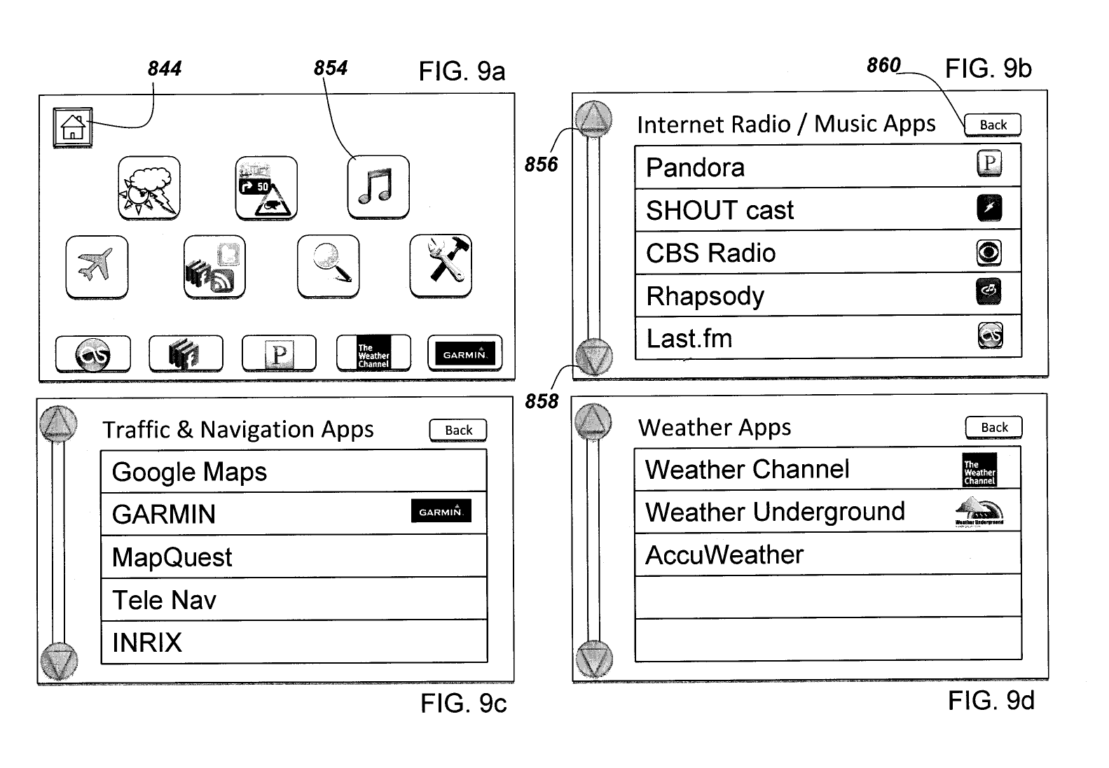

FIG. 9a illustrates the display screen of FIG. 8a after the user has selected the smartphone icon. Although the screen of FIG. 9a has the same content as shown in FIG. 8b, the icons are arranged differently. In one embodiment, the icons are arranged in the top two rows of the screen in the order of how recently each of the icons has been selected by the user.

FIG. 9b illustrates the display screen of FIG. 9a after the user has selected the music icon; FIG. 9c illustrates the display screen of FIG. 9a after the user has selected the traffic and navigation icon; and FIG. 9d illustrates the display screen of FIG. 9a after the user has selected the weather icon.

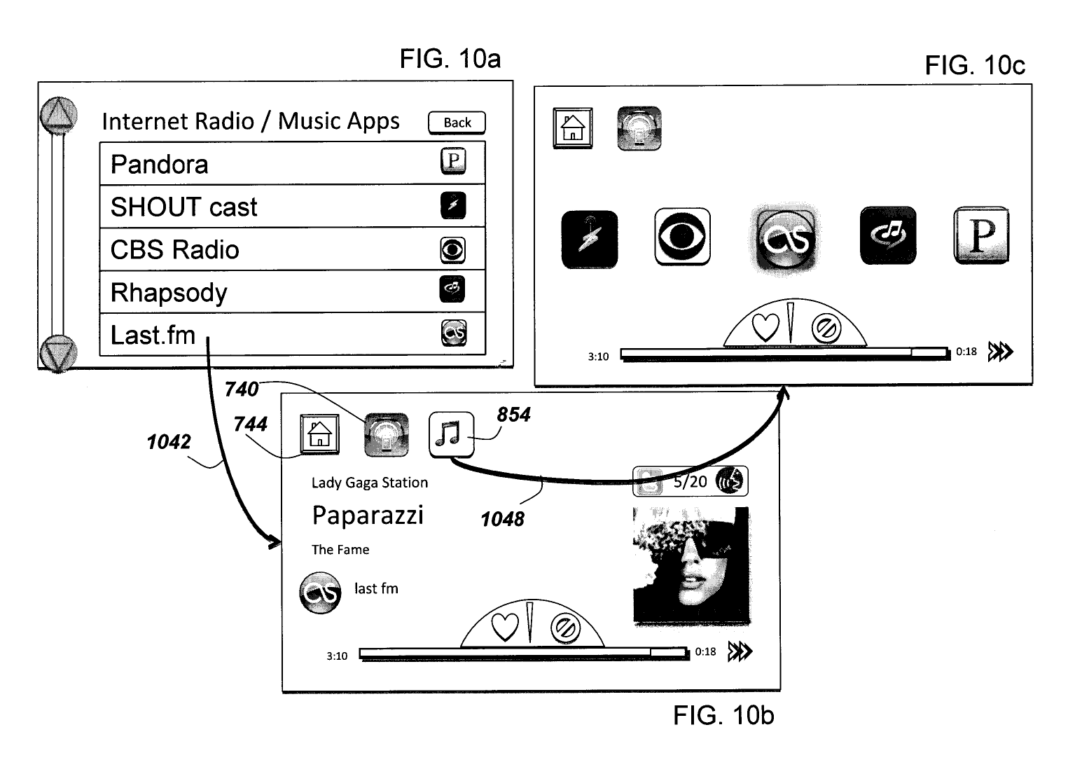

FIG. 10a again illustrates the display screen of FIG. 9a after the user has selected the music icon. The user may select the Last.fm selection, as indicated by arrow 1042, thereby causing the display screen of the head unit to display the Last.fm screen shown in FIG. 10b. On this screen too, the user has the option of selecting the smartphone icon 740 to thereby cause the display screen of the head unit to revert to the display shown in FIG. 8b. Here too, the user has the option to select the home icon 744, which would cause the head unit to return to the display shown in FIG. 7a. Lastly, the user may select the music icon 854, as indicated by arrow 1048, thereby causing the display screen of the head unit to display the icons for the available music services, as shown in FIG. 10c. These music service icons include icons for SHOUT cast, CBS radio, Last.fm, Rhapsody, and Pandora. Last.fm, by virtue of being the most recently selected music service, may be displayed in a most prominent location in the screen of FIG. 10c, such as in the middle of the screen as shown.

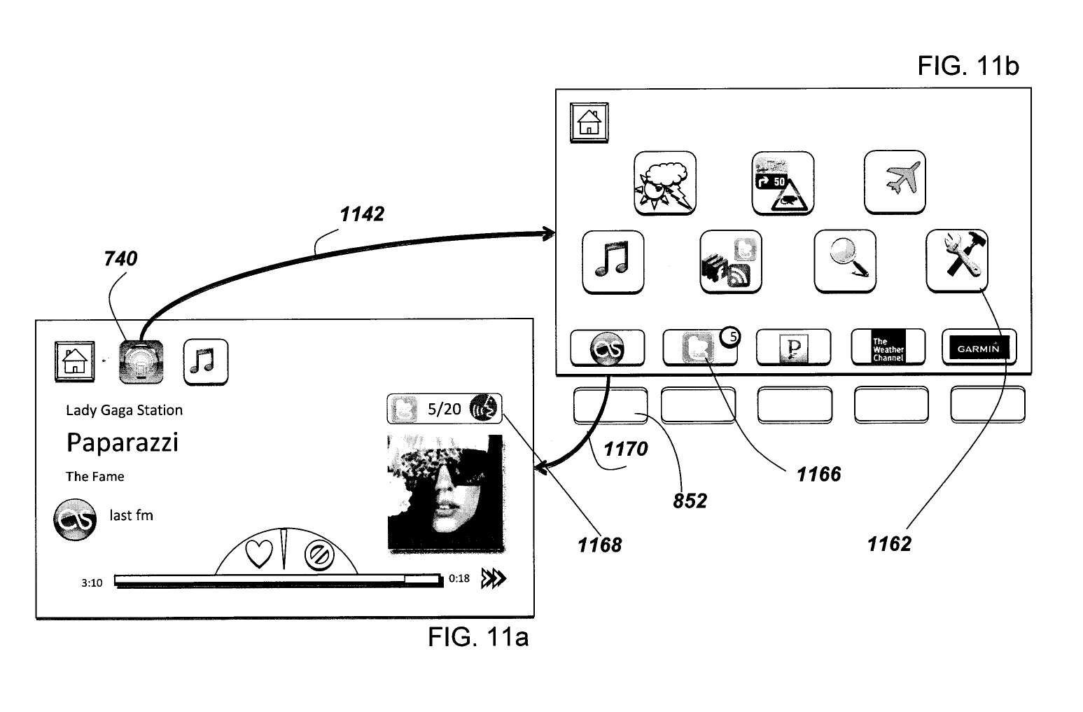

FIG. 11a again illustrates the display screen of FIG. 10b after the user has selected the Last.fm selection. In another embodiment, when the user selects the smartphone icon 740, as indicated by arrow 1142, the display screen of the head unit reverts to the display shown in FIG. 8b, as shown in FIG. 11b. The tools icon 1164 may be optional. In this example of FIG. 11b, a Twitter icon 1166 is included as a favorite instead of the Facebook icon shown in FIG. 8b. As indicated at 1168, upon a voice command from the user, the system may read Twitter aloud. Text to Speech (TTS) may read Twits, and a slider may appear on the audio screen (e.g., at a fixed consistent location). Selection of the Last.fm icon (i.e., depressing the pushbutton 852 directly below the Last.fm icon), as indicated by arrow 1170, returns operation to the screen of FIG. 11a.

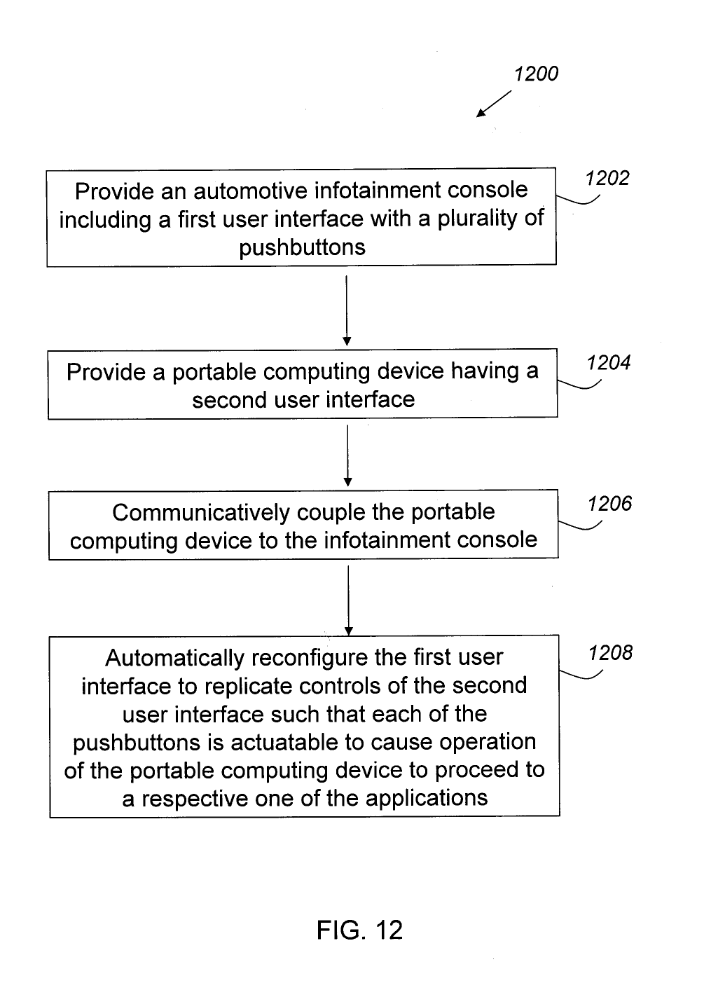

FIG. 12 illustrates a control method 1200 of the present invention. In a first step 1202, an automotive infotainment console is provided including a first user interface with a plurality of pushbuttons. As shown in FIG. 1, infotainment console 18 includes a user interface 30 with a plurality of pushbuttons 852 (FIG. 8b).

In a next step 1204, a portable computing device is provided having a second user interface. The portable computing device is operable to run a plurality of applications. For example, a portable computing device 36, such as a smartphone, has a user interface as shown in FIG. 2a. The smartphone is operable to run applications such as Facebook and Twitter (FIG. 3a) within the category of social applications.

Next, in step 1206, the portable computing device is communicatively coupled to the infotainment console. In the embodiment of FIG. 1, infotainment system 11 includes wireless communication device 28, which is communicatively coupled and connected to infotainment console 18. Wireless communication device 28 is adapted to transmit information to portable/mobile electronic device 36 and receive information from portable/mobile electronic device 36. Wireless communication device 28 may be any communication device capable of wirelessly communicating with a portable/mobile electronic device. For instance, wireless communication device 28 may be in the form of a short range communications device such as a radio frequency communications module, a Wi-Fi communications module, IEEE 802.11 communications module, or a Bluetooth communications module. Alternatively, infotainment console 18 may be selectively, removably and/or temporarily hardwired to portable computing device 36, and communication may occur therebetween via the hardwired connection.

In a final step 1208, the first user interface is automatically reconfigured to replicate controls of the second user interface such that each of the pushbuttons is actuatable to cause operation of the portable computing device to proceed to a respective one of the applications. For example, as shown in FIG. 8b, the user interface of the automotive console includes a display screen that is automatically reconfigured to include icons 850 and/or 851 that may be displayed on the user interface of the smartphone with which the automotive console is in communication. Moreover, pushbuttons 852 may be pressed in by the user to cause operation of the smartphone to proceed to the applications represented by icons 850 disposed adjacent to pushbuttons 852.

The display screen of the automotive console may be touch-sensitive such that icons 851, and possibly shortcut icons 850, may be selected by the user by touching the icons, similarly to how the user may select applications by touching the screen of the smartphone shown in FIGS. 2-5.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as, come within known or customary practice in the art to which this invention pertains.

What is claimed is:

1. A control arrangement for a vehicle, comprising:
an infotainment console including a user interface having a plurality of pushbuttons; and
a communication device communicatively coupled to the infotainment console and adapted to relay signals between the infotainment console and a portable computing device, wherein the infotainment console is configured to reconfigure the user interface to enable the user to control the portable computing device via the user interface, such that each of the pushbuttons is actuatable to cause operation of the portable computing device to proceed to a respective application within the portable computing device.

2. The arrangement of claim 1 wherein the user interface comprises a first user interface including a touch screen display, the portable computing device having a second user interface, the infotainment console being configured to reconfigure the touch screen display to replicate at least one touch-selectable button of the second user interface.

3. The arrangement of claim 1 wherein the user interface of the infotainment console comprises a first user interface, the portable computing device having a second user interface, the infotainment console being configured to:
interrogate the portable computing device regarding a configuration of the second user interface of the portable computing device;
receive responses to the interrogation from the portable computing device; and
substantially replicate a layout and functions of the second user interface on the first user interface.

4. The arrangement of claim 1 wherein said communication device is a radio frequency communications module.

5. The arrangement of claim 1 wherein the pushbuttons comprise a plurality of radio preset pushbuttons.

6. The arrangement of claim 1 wherein the user interface includes a display screen having an edge disposed adjacent to the pushbuttons, a plurality of icons being disposed along the edge of the display screen, each of the icons being disposed adjacent to a respective one of the pushbuttons, each of the icons representing a respective said application associated with the respective pushbutton.

7. The arrangement of claim 6 wherein the icons comprise application icons, a plurality of application category icons being displayed on the display screen simultaneously with the application icons, each of the application category icons being selectable to cause a respective category of the application icons to be presented on the display screen.

8. A control method, comprising:
providing an automotive infotainment console including a first user interface with a plurality of pushbuttons;
providing a portable computing device having a second user interface and being operable to run a plurality of applications;
communicatively coupling the portable computing device to the infotainment console; and
automatically reconfiguring the first user interface to replicate controls of the second user interface such that each of the pushbuttons is actuatable to cause operation of the portable computing device to proceed to a respective one of the applications.

9. The method of claim 8 wherein the first user interface includes a touch screen display, the method comprising the further step of reconfiguring the touch screen display to replicate at least one touch-selectable button of the second user interface.

10. The method of claim 8 comprising the further steps of:
interrogating the portable computing device regarding a configuration of the second user interface of the portable computing device;
receiving responses to the interrogation from the portable computing device; and
substantially replicating a layout and functions of the second user interface on the first user interface.

11. The method of claim 8 wherein the portable computing device is communicatively coupled to the infotainment console via a radio frequency communications module.

12. The method of claim 8 wherein the pushbuttons comprise a plurality of radio preset pushbuttons.

13. The method of claim 8 wherein the user interface includes a display screen having an edge disposed adjacent to the pushbuttons, a plurality of icons being disposed along the edge of the display screen, each of the icons being disposed adjacent to a respective one of the pushbuttons, each of the icons representing a respective said application associated with the respective pushbutton.

14. The method of claim 13 wherein the icons comprise application icons, a plurality of application category icons being displayed on the display screen simultaneously with the application icons, each of the application category icons being selectable to cause a respective category of the application icons to be presented on the display screen.

15. A control arrangement for a vehicle, comprising:
a head unit of an audio entertainment system including a user interface having a display screen and a plurality of radio preset pushbuttons disposed adjacent to the display screen; and
a communication device communicatively coupled to the audio entertainment system and adapted to relay signals between the audio entertainment system and a smartphone, wherein the audio entertainment system is configured to reconfigure the user interface to enable the user to control the smartphone via the user interface, such that a plurality of application icons appear on the display screen, each of the application icons representing a respective application within the smartphone, each of the application icons being disposed adjacent to a respective one of the pushbuttons, each of the pushbuttons being actuatable to cause the smartphone to run the respective application, a plurality of application category icons being displayed on the display screen simultaneously with the application icons, each of the application category icons being selectable to cause a respective category of the applications to be presented on the display screen.

16. The arrangement of claim 15 wherein the user interface comprises a first user interface including a touch screen display, the smartphone having a second user interface, the audio entertainment system being configured to reconfigure the touch screen display to replicate at least one touch-selectable button of the second user interface.

17. The arrangement of claim 15 wherein the user interface of the audio entertainment system comprises a first user interface, the smartphone having a second user interface, the audio entertainment system being configured to:
interrogate the smartphone regarding a configuration of the second user interface of the smartphone;
receive responses to the interrogation from the smartphone; and
substantially replicate a layout and functions of the second user interface on the first user interface.

18. The arrangement of claim 15 wherein said communication device is a radio frequency communications module.

19. The arrangement of claim 15 wherein the audio entertainment system is configured to, in response to a voice command, implement text to speech to thereby read content of a social networking type of said application.

20. The arrangement of claim 15 wherein each of the application category icons is selectable to cause a plurality of applications in a respective category to be presented in text form on the display screen, each of the presented text form applications being touch-sensitive such that the user may press on each of the presented text form applications for a predetermined length of time to thereby cause an icon of the respective application to be added as a shortcut in association with a respective one of the pushbuttons.
